(19) United States
(12) Patent Application Publication
(10) Pub. No.: US 2025/0119759 A1
(43) Pub. Date: Apr. 10, 2025

(54) METHOD FOR ADAPTING THE NUMBER OF ACTIVE DIGITAL PROCESSING COMPONENTS IN A RADIO NETWORK

(71) Applicant: Telefonaktiebolaget LM Ericsson (publ), Stockholm (SE)

(72) Inventors: Pål FRENGER, Linköping (SE); Jonas BENGTSSON, Häljarp (SE); Niklas WERNERSSON, Kungsängen (SE)

(21) Appl. No.: 18/293,743

(22) PCT Filed: Aug. 10, 2021
(86) PCT No.: PCT/EP2021/072318

§ 371 Date: Jan. 30, 2024

(51) Int. Cl. H04W 24/02; H04W 72/0446; H04W 72/12; H04W 76/28

(52) U.S. Cl. CPC H04W 24/02; H04W 72/0446; H04W 72/12; H04W 76/28

(57) ABSTRACT

Methods and apparatuses for a radio network are disclosed. According to an embodiment, the method includes adapting the number of active digital processing components included in a radio network based on an estimate of a required processing capacity for an estimated combined time-averaged traffic volume relating to a plurality of cells of the radio network; and scheduling transmissions relating to the plurality of cells so that processing requirements of the transmissions do not exceed a processing capacity of the active digital processing components.

### TECHNICAL FIELD

Embodiments of the disclosure generally relate to a method for a radio network and, more particularly, to methods and apparatuses for scheduling in a radio network.

### BACKGROUND

This section introduces aspects that may facilitate better understanding of the present disclosure. Accordingly, the statements of this section are to be read in this light and are not to be understood as admissions about what is in the prior art or what is not in the prior art.

In cellular radio access networks (RAN), centralized processing of higher layer functions (e.g. MAC, RLC, PDCP) is an increasingly important deployment solution. In relation to the arrangement of a radio network such as a RAN, radio transmitters and receivers need to be distributed and placed close to physical antennas, but with advances in transport solutions many other functions can be placed in a more centralized location.

FIG. 1 illustrates an example of a radio network in which the compute resources 102 are centralized, whereby a plurality of radio units 104 (which are arranged in close proximity to a plurality of antennas 106) are in communication with the compute resources 102 (in this example, baseband compute node resources). A motivation for a deployment with centralized compute resources is that it enables sharing of compute hardware, resulting in reduced energy consumption. However, with the sharing of resources, the resources are required to have a capacity to support transmissions from a plurality of different sources, rather than just one. It is desirable to provide a system in which transmissions are efficiently managed where resources are shared.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for scheduling transmission in a radio network with centralized resources.

According to a first aspect of the disclosure, there is provided a method for a radio network. The method comprises adapting the number of active digital processing components comprised in a radio network based on an estimate of a required processing capacity for an estimated combined time-averaged traffic volume relating to a plurality of cells of the radio network. The method also comprises scheduling transmissions relating to the plurality of cells so that processing requirements of the transmissions do not exceed a processing capacity of the active digital processing components.

In this way, energy consumption of the radio network is reduced, as the number of active digital processing components is minimized for the traffic volume (for example, the traffic over a time period) and the scheduling may be performed so that transmissions are distributed such that they do not exceed the processing capacity of the active digital processing components.

For example, the adaption of the number of active digital processing components may comprise turning the digital processing components on or off. The digital processing components may be the components used to process and/or schedule transmissions. The digital processing components may relate to baseband processing. The digital processing components may be shared by the plurality of cells. The radio network may be a radio access network (RAN).

The estimated combined time-averaged traffic volume may be based on the known traffic volume of a preceding time. For example, the traffic from the last 10 seconds may be used to estimate the combined time-averaged traffic volume of the next 10 seconds. Alternatively, the estimated combined time-averaged traffic volume may be based on an assumption that traffic is similar at the same time each day, where the traffic at the same time of a preceding day is used to estimate the combined time-averaged traffic volume (or, for example, it is assumed that the same day each week has the same traffic volume). The estimated combined time-averaged traffic volume may be determined using an algorithm. It will be appreciated that any appropriate methods may be used to estimate the combined time-averaged traffic volume.

Using the estimated combined time-averaged traffic volume, the number of active digital processing components that are required in order that sufficient processing power is provided to process the average traffic volume may be determined. For example, the average traffic volume will require less processing power than peak traffic volume. Therefore, the number of active digital processing components can be adapted accordingly. The scheduling of transmissions may then distribute transmissions so that the transmissions do not exceed the average traffic volume.

The digital processing components may be shared hardware resources (e.g compute resources) comprised in a compute node (e.g. a shared compute node, a RAN compute node, a baseband compute node) serving the plurality of cells. The shared hardware resources may comprise at least one of: a central processing unit core, a digital signal processor core, an accelerator core, an application-specific integrated circuit, a field programmable gate array, and so on. The scheduling may be performed by a (common radio resource) scheduler, for example comprised in the compute node. The digital processing components may be comprised in the compute node.

Thus, energy consumption in a radio network compute node may be reduced by adapting the number of active compute resources to the current aggregated traffic in multiple cells and scheduling traffic accordingly.

The digital processing components may be interfaces of a transport connection between the plurality of cells and a centralized processing unit. The rate of the transport connection may be adapted. A proportion of cells scheduled in the same time slots may correspond to the processing capacity of the active interfaces (e.g. the proportion of active interfaces). Fewer cells may be scheduled in the same time slot when the processing capacity of the active interfaces is lower (e.g. than a maximum processing capacity). For example, fewer cells than the number of cells which share the active digital processing components (or a proportion of cells of the number of cells which share the active digital processing components) may be scheduled.

Thus, energy consumption in transport interface equipment may be reduced by adapting the supported rate to the current aggregated traffic in multiple cells, and scheduling the traffic accordingly.

The method may further comprise, prior to the adapting of the number of active digital processing components, obtaining the estimated combined time-averaged traffic volume relating to the plurality of cells, and determining the estimate of the required processing capacity to support the estimated combined time-averaged traffic volume.

The number of active digital processing components may be adapted to the minimum number of active digital processing components which can provide the required processing capacity for the estimated combined time-averaged traffic volume.

In this way, the energy consumption of the digital processing components may be reduced.

The scheduling may further comprise scheduling transmissions (or traffic) so that transmissions (or traffic) in a time slot do not exceed the processing capacity of the active digital processing components.

The scheduling may comprise delaying a proportion of transmissions (or traffic) in a time slot where transmissions (or traffic) in the time slot would exceed the processing capacity of the active digital processing components. For example, where the combined traffic of the plurality of cells in a time slot, or at a particular time, would exceed the processing capacity of the active digital processing components, some of the traffic may be delayed in order that the combined traffic in any time slot (e.g. instantaneous traffic) does not exceed the processing capacity of the active digital processing components.

The scheduling may further comprise maximizing the number of discontinuous transmissions of at least one cell of the plurality of cells.

By maximizing the number of discontinuous transmissions in combination with the scheduling of transmissions so that processing requirements of the transmissions do not exceed a processing capacity of the active digital processing components, where the number of active digital processing components comprised in a radio network is adapted based on an estimate of a required processing capacity for an estimated combined time-averaged traffic volume relating to the plurality of cells, further energy savings are made in the radio units of the cells, which can be inactive during periods of no transmission.

The number of cells scheduled (e.g. transmissions relating to a cell scheduled) in the same time slot may be restricted to one cell per time slot. By scheduling one cell at a time, the peak workload in the digital processing components may be reduced as the digital processing components only have to deal at most with the maximum requirements of one cell rather than the maximum requirements of more than one cell in combination. Furthermore, the number of discontinuous transmissions (DTX) in each cell may remain the same with respect to the original traffic if cells are scheduled in different time slots, which provides the radio units serving the cells with periods where they are not required to be active, thereby increasing energy savings.

The scheduling of transmissions may further comprise scheduling at least two cells of the plurality of cells in different time slots. Cells that share a multi-band radio unit may be scheduled in the same time slots. Cells that do not share a multi-band radio unit may be scheduled in different time slots to time slots of cells that share the multi-band radio unit. Thus, radio units may save energy as the number of discontinuous transmissions may be increased. (For example, as the multi-band radio unit is required to operate when any cell that shares the multi-band radio unit is scheduled, cells that do not share the multi-band unit may be scheduled in time slots different to those of cells that share the multi-band unit, so that there are periods of discontinuous transmissions for the multi-band unit and another radio unit.)

The number of cells scheduled in the same time slot may be based on the estimate of a required processing capacity. For example, each cell may have a maximum amount of traffic. Therefore, the estimate of a required processing capacity can be based on the combined maximum amount of traffic for the cells, where the number of cells scheduled in the same time slot have a combined maximum amount of traffic with a processing requirement less than the required processing capacity of the active digital processing components.

At least one cell may use a reduced performance transmission format for transmission. The reduced performance transmission format may comprise at least one of: lower order modulation; larger bandwidth; wider beamforming; no interference suppressing beamforming; reduced complexity (and less capable) interference suppression beamforming; no data compression, etc. Using a reduced performance transmission format may further increase energy savings. By scheduling different cells in different time slots, lower performance transmission formats may be used as there is less interference between transmissions from different cells.

The processing capacity may be based on at least one of: uplink; downlink; both uplink and downlink.

User equipment, UEs, in the same cell and scheduled in the same time slot may be coordinated in the frequency domain.

According to a further aspect there is provided a system for reducing energy consumption of a radio network. The system comprises an adapter configured to adapt the number of active digital processing components comprised in the network based on an estimate of a required processing capacity for an estimated combined time-averaged traffic volume relating to a plurality of cells of the radio network. The system further comprises a scheduler configured to schedule transmissions relating to the plurality of cells so that processing requirements of the transmissions do not exceed a processing capacity of the active digital processing components.

It will be appreciated that the scheduler may be comprised in any part of the network, and the adapter and/or the digital processing components may be comprised in any part of the network, in the same component as the scheduler or a different component.

The system may be adapted to perform the methods described herein.

According to a further aspect there is provided a system comprising a processor and a memory, said memory containing instructions executable by said processor whereby said system is operative to adapt the number of active digital processing components comprised in a radio network based on an estimate of a required processing capacity for an estimated combined time-averaged traffic volume relating to a plurality of cells of the radio network. The system is also operative to schedule transmissions relating to the plurality of cells so that processing requirements of the transmissions do not exceed a processing capacity of the active digital processing components.

According to a further aspect there is provided a computer-readable storage medium, having stored thereon a computer program configured to perform the methods described herein.

According to a further aspect there is provided a computer program, comprising instructions which, when executed on at least one processor, cause the at least one processor to carry out any of the methods described herein.

According to a further aspect there is provided a carrier containing the computer program, wherein the carrier is one of an electronic signal, optical signal, radio signal, or computer readable storage medium.

According to a further aspect there is provided a compute node configured to perform the methods described herein.

According to a further aspect there is provided a transport connection configured to perform the method as described herein.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating centralized processing in a radio network;

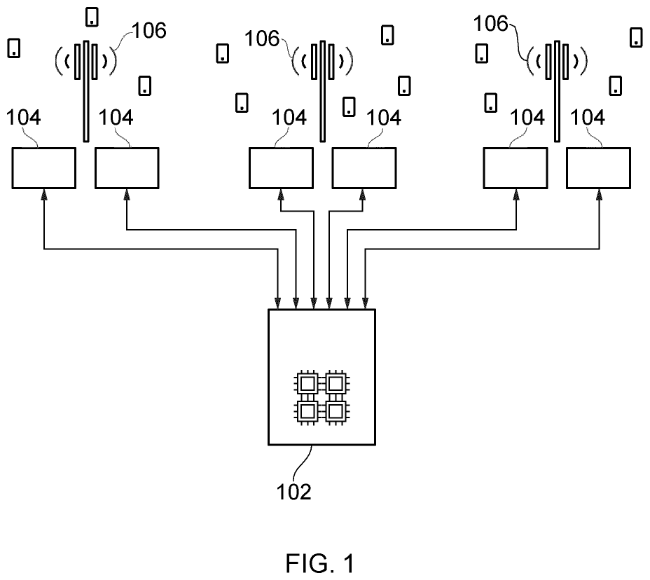

FIG. 2 is a diagram illustrating a low energy scheduling solution;

FIG. 3 is a diagram illustrating low energy scheduling for two cells;

FIG. 4 is a diagram illustrating an example of processing requirements for a centralized processing unit when low energy scheduling is used for two cells;

FIG. 5 is a flow chart showing a method according to an example;

FIG. 6a is a diagram illustrating scheduling without the methods described herein;

FIG. 6b is a diagram illustrating scheduling using methods described herein;

FIG. 7a is a diagram illustrating low energy scheduling without the methods described herein;

FIG. 7b is a diagram illustrating low energy scheduling using methods described herein;

FIG. 8 is a diagram illustrating scheduling using methods described herein;

FIG. 9 is a diagram illustrating scheduling for cells which share a multi-band radio unit and a cell which does not share the multi-band radio unit;

FIG. 10 is a diagram illustrating a fronthaul connection towards a shared RAN compute node;

FIG. 11 illustrates a system according to an example; and

FIG. 12 illustrates a system according to an example.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

As is discussed above, centralized processing of higher layer functions (e.g. MAC, RLC, PDCP) is an increasingly important deployment solution in cellular radio access networks. A motivation for a deployment with centralized compute resources is that it enables sharing of compute hardware, resulting in reduced energy consumption. However, the sharing of compute resources may require that a large number of compute resources are active to support the maximum possible instantaneous transmission across all cells which utilize the shared compute resources. It is therefore desirable to develop methods of scheduling which effectively manage transmissions in order to reduce energy consumption.

One current energy saving method, low energy scheduling solution (LESS), in radio base stations (e.g. radio units) of a radio network is to ensure that traffic is concentrated in the time domain by delaying user traffic slightly, so that traffic is grouped. This enables a larger number of discontinuous transmission (DTX). A larger number of discontinuous transmissions is beneficial as radio power amplifiers may enter a low power consuming sleep state during the discontinuous transmissions (e.g. whenever there is nothing to transmit over the radio) where a larger number of discontinuous transmissions thereby reduces energy consumption.

In order to implement this low energy scheduling, a scheduler in the radio base station delays some transmissions (e.g. packets) by a small amount (e.g. a few ms) and tries to generate as many time-gaps as possible with no transmissions.

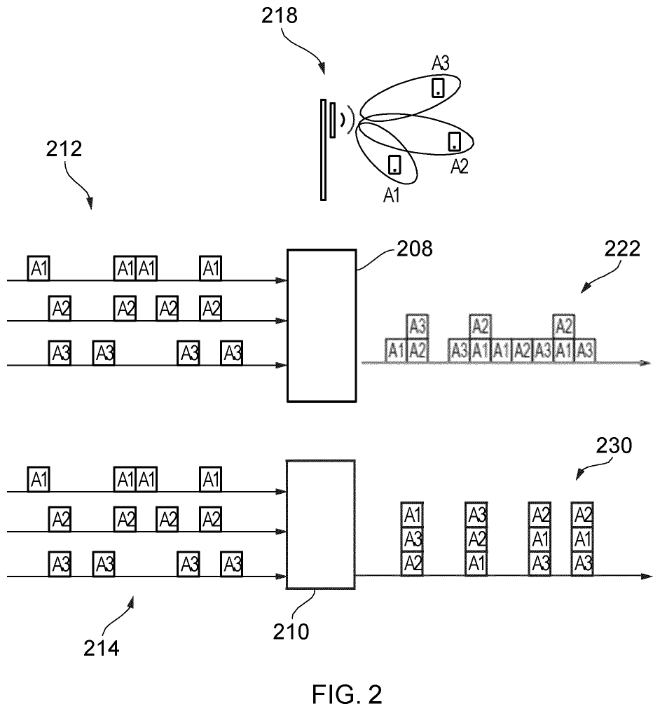

An example of the operation of a canonical scheduler and a low energy scheduler is depicted in FIG. 2. As is illustrated here, schedulers 208, 210 are assumed to be in communication with a cell 218 which serves a plurality of users (A1, A2, A3). The canonical scheduler 208 processes traffic 212 from different users (A1, A2, A3), and does not alter the relative time of transmissions. The low energy scheduler 210, in contrast, groups transmissions 214 from different users (A1, A2, A3) so that in the scheduled transmissions 230 there are more time gaps with no transmissions.

The canonical scheduler results in traffic being more spread out over the time slots, whereas the low energy scheduler results in greater transmission peaks. When the traffic is low (which is most of the time in a typical base station) a low energy scheduler can enable large energy savings in the radio power amplifiers.

While a low energy scheduler increases the number of DTX in a single cell, it also increases the instantaneous peak traffic (as is shown in FIG. 2). For a single cell this may not be a significant problem. However, when there are multiple cells there is a risk that the instantaneous traffic peaks align in time causing even larger variations of aggregated instantaneous traffic with high peaks.

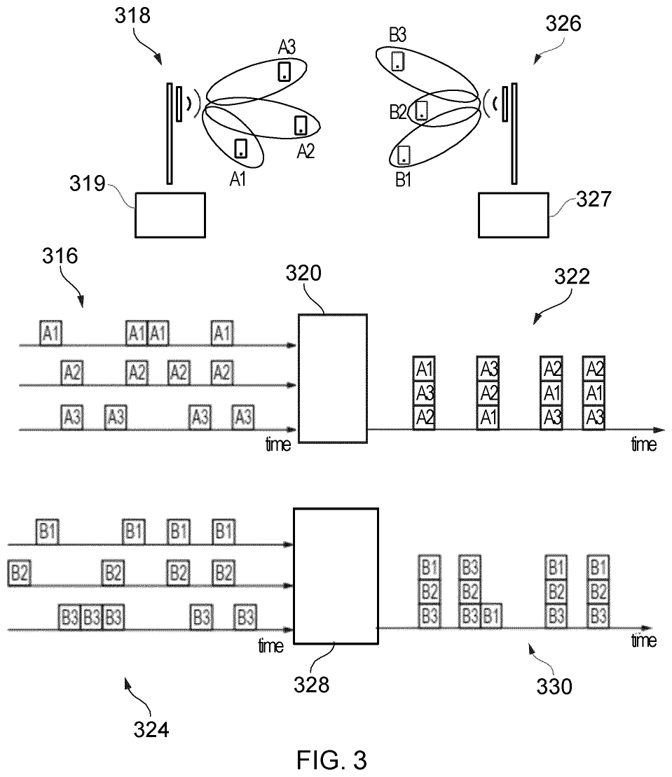

An example of low energy scheduling for multiple cells is illustrated in FIG. 3. FIG. 3 illustrates low energy scheduling for traffic for cell A 318 and cell B 326. In particular, FIG. 3 illustrates a radio network comprising cell A 318 and cell B 326 served by radio unit A 319 and radio unit B 327 respectively, where cell A serves users A1, A2 and A3, and cell B serves users B1, B2 and B3. Traffic 316 in cell A 318 and traffic 324 in cell B 326 is scheduled by scheduler A 320 and scheduler B 328 respectively. Scheduler A 320 and scheduler B 328 are low energy schedulers configured to generate traffic with more DTX but with higher peaks. In particular, traffic 316 from user activity in cell A 318 is scheduled by scheduler A 320, where the scheduled transmissions 322 have higher peaks but more DTX than the combined traffic 316 from user activity in cell A. Similarly, traffic 324 from user activity in cell B 326 is scheduled by scheduler B 328, where the scheduled transmissions 330 have higher peaks but more DTX than the combined traffic 324 from user activity in cell B.

The grouping of traffic in this manner is advantageous as it enables more DTX. However, as can be seen in this Figure, the grouping results in some of the traffic peaks from cell A 318 and cell B 326 occurring at the same time (e.g. in the same time slot). Thus, in this configuration, multiple cells may have instantaneous traffic peaks at the same time. In a network which operates using shared compute resources these instantaneous peaks can add up substantially, which requires many compute resources. Activation of additional compute resources takes time, and therefore, to ensure that all instantaneous traffic can be served, a large excess compute capacity needs to be active even when traffic is low on average. This reduces the energy saving potential of centralized processing in a radio access network.

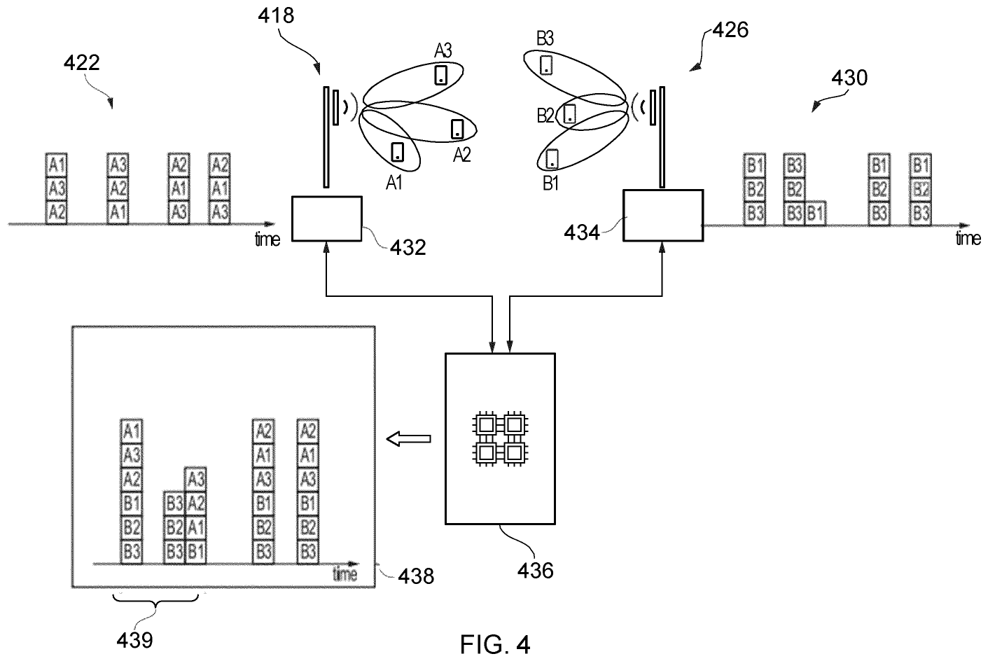

FIG. 4 illustrates an example deployment with two cells that share compute resources (digital processing components) (in this case, the same baseband compute node). A state-of-the-art (SOTA) low energy scheduling solution (LESS) is applied for each cell (for example, as illustrated in FIG. 3). As a result, all CPU cores in this example are required to handle the large aggregated instantaneous peak traffic instances.

In particular, FIG. 4 shows scheduled transmissions for cell A 418 (serving users A1, A2 and A3) and cell B 426 (serving users B1, B2 and B3) which have been scheduled by a low energy scheduler so that the scheduled transmissions 422, 430 for each cell has more DTX. In this example, radio unit A 432 corresponding to cell A and radio unit B 434 corresponding to cell B share digital processing components, which in this example are compute resources 436 (e.g. processing cores) which may be a part of edge computing or cloud computing. The compute resources of this example are baseband compute resources. As is further illustrated in this Figure, the workload of the combined transmissions 438 for cell A 418 and cell B 426 is high in time slots where there is activity from both cell A and cell B. The required work load of the processing cores 435 is illustrated by the dotted line, where the required work load is based on the maximum amount of instantaneous traffic, and in this example requires all compute resources 436. Compute resources 436 may be prevented from being turned off in such a configuration, as often the activation time 439 of the compute resources 436 is longer than the time gap between traffic peaks (where sufficient processing capacity must be available for traffic). Placing multiple instances of the low energy scheduling solution (LESS) in the same baseband compute unit may therefore result in aggregated traffic peaks. This requires more compute resources to be kept active, resulting in reduced potential for resource sharing and energy savings.

Furthermore, transmissions scheduled in this manner will interfere with one another, which results in increased energy usage as more advanced antenna processing, more bandwidth, more retransmissions and so on are required to deal with interference.

For example, several variants of interference aware coordination of transmissions in multiple cells are standardized for both LTE and NR. For example, the first LTE release (Rel-8) included support for coordination of transmissions in different cells. To reduce inter-cell interference different cells can make use of ICIC (intercell interference coordination) to avoid or limit the impact of colliding transmissions from different cells in certain physical resource blocks (PRBs).

The ICIC functionality was further extended in later releases with faster interference control mechanisms such as dynamic point selection (in which a downlink transmission can quickly switch from one transmission point to another) and fast coordination mechanisms for small cell on-off (based on interference and traffic). These two examples can be viewed as special forms of CoMP (coordinated multi-point transmission).

Thus, LESS is a solution to reduce energy consumption in a radio unit, however, it may result in high traffic load variations in aggregated processing nodes, thereby actually resulting in higher energy consumption in some parts of the radio network. Furthermore, even without increasing the amount of DTX in a cell using LESS, aggregation of traffic will increase the variations between average and peak traffic. There is therefore a need for a more efficient solution to coordinate transmissions in multiple cells.

To address these issues, in a first example there is a method for a radio network, the method comprising adapting the number of active digital processing components comprised in a radio network based on an estimate of a required processing capacity for an estimated combined time-averaged traffic volume relating to a plurality of cells of the radio network; and scheduling transmissions relating to the plurality of cells so that processing requirements of the transmissions do not exceed a processing capacity of the active digital processing components.

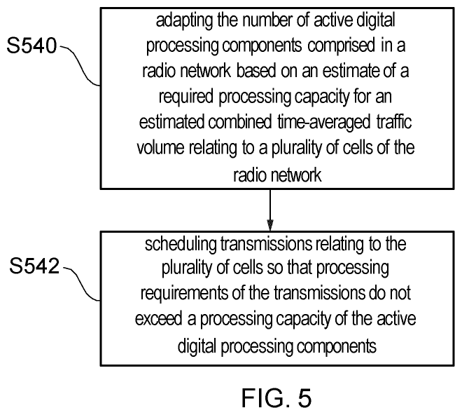

FIG. 5 illustrates the method according to an example, where the method comprises a first step S540 of adapting the number of active digital processing components comprised in a radio network based on an estimate of a required processing capacity for an estimated combined time-averaged traffic volume relating to a plurality of cells of the radio network, and a second step S542 of scheduling transmissions relating to the plurality of cells so that processing requirements of the transmissions do not exceed a processing capacity of the active digital processing components.

The method may further comprise, prior to the adapting of the number of active digital processing components, obtaining the estimated combined time-averaged traffic volume relating to the plurality of cells, and determining the estimate of the required processing capacity to support the estimated combined time-averaged traffic volume. It will be appreciated that the scheduling of the method may be performed by a centralized scheduler (scheduling unit).

In one example, the digital processing components are shared hardware resources comprised in a compute node serving the plurality of cells. The shared hardware resources may comprise at least one of: a central processing unit core, a digital signal processor core, an accelerator core, an application-specific integrated circuit, a field programmable gate array.

It is noted that while the following examples illustrate scheduling with respect to two or three cells, it will be appreciated that the methods described herein could be applied to a network comprising any number of cells that share digital processing components. Furthermore, while the examples herein are described in relation to processing capacity based on uplink, it will be appreciated that the invention may be equally applicable to downlink and a combination of uplink and downlink.

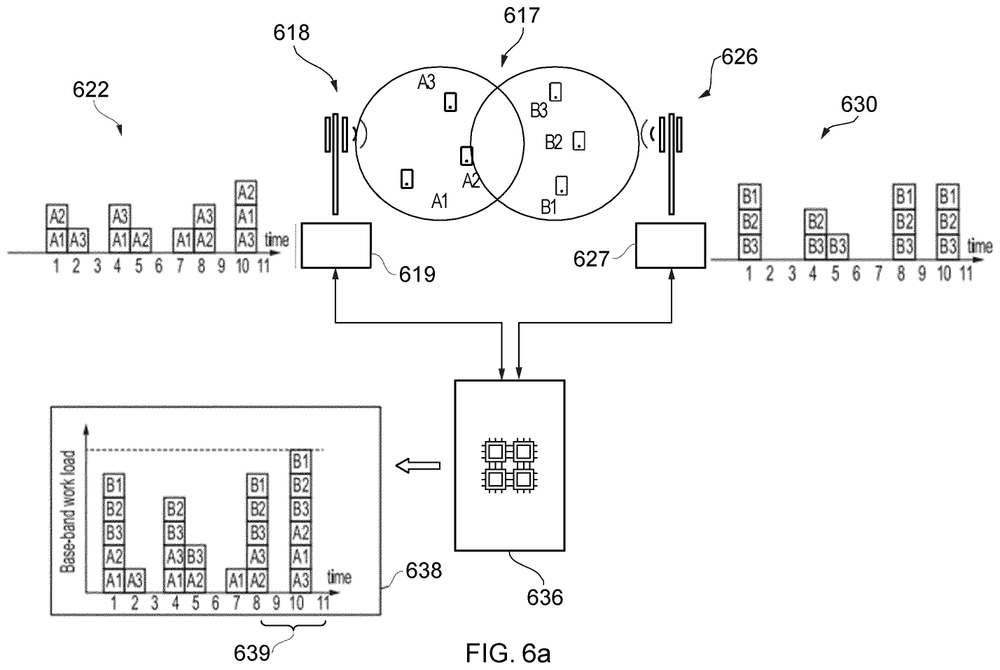

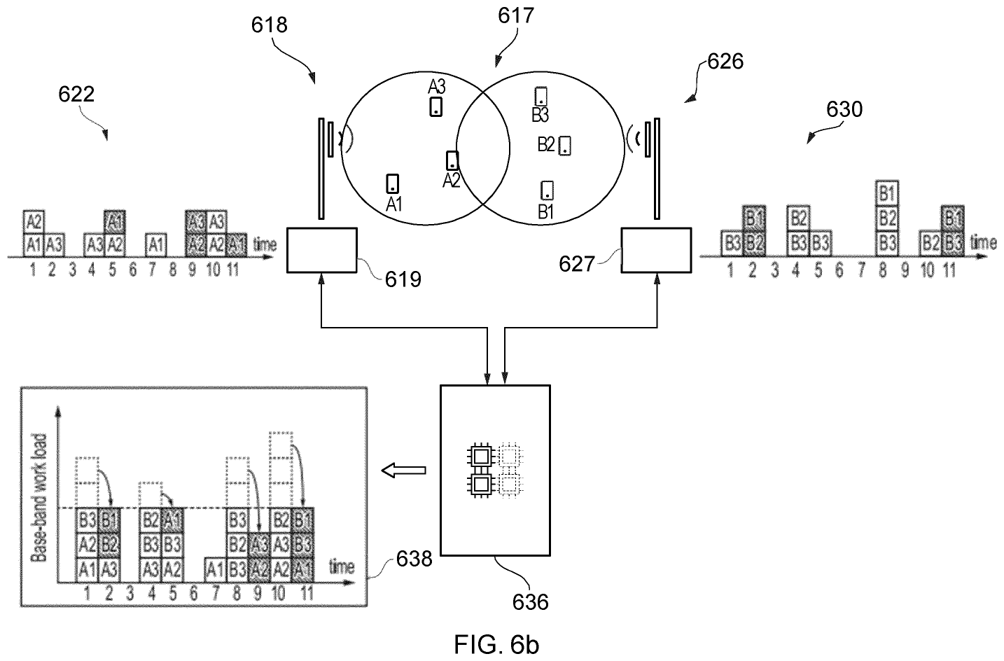

An example is illustrated in FIG. 6, where FIG. 6a illustrates a configuration of a radio network 617, and FIG. 6b illustrates a configuration of a radio network 617 which implements the methods described herein. In particular, FIG. 6b illustrates an example in which the scheduling is performed in accordance with methods described herein.

FIG. 6a illustrates a radio network 617 comprising cell A 618 and cell B 626 served by radio unit A 619 and radio unit B 627 respectively. Cell A 618 and cell B 626 share the same digital processing components (compute resources 636) (in this example, compute resources of the same RAN compute node). Each cell serves three UEs (A1, A2, A3 in cell A 618 and B1, B2, B3 in cell B 626). The traffic 622 corresponding to cell A and the traffic 630 corresponding to cell B are illustrated here with respect to time slots (labelled 1 to 11). The combined traffic 638 of cell A and cell B in each time slot is illustrated with respect to the compute resource (baseband) work load, where a dotted line indicates the peak baseband compute capacity. In some time slots (e.g. time slot 10) many UEs are active at the same time which generates a need for high compute capacity in the shared compute resource 636.

If the activation time 639 of the compute resources is larger than the traffic transmission time interval (TTI) it is not possible to reduce energy consumption in the shared RAN compute node by deactivating some of the digital processing components, as otherwise the digital processing components will not be available for traffic when required. For example, if the activation time 639 of the compute resources takes four time slots, it is not possible for the compute resources to be turned on and off between traffic peaks in the example shown in FIG. 6a.

FIG. 6b illustrates an example in which the methods described herein are implemented to address the shortcomings of FIG. 6a.

In particular, FIG. 6b illustrates the same traffic scenario as shown in FIG. 6a but scheduling using the methods described herein. In particular, FIG. 6b illustrates a radio network 617 comprising cell A 618 and cell B 626 served by radio unit A 619 and radio unit B 627 respectively. Cell A 618 and cell B 626 share the same digital processing components (compute resource 636, in this example of the same RAN compute node). Each cell serves three UEs (A1, A2, A3 in cell A 618 and B1, B2, B3 in cell B 626). The traffic 622 corresponding to cell A and the traffic 630 corresponding to cell B are illustrated here with respect to time slots (labelled 1 to 11).

However, in addition, a shared resource scheduler is provided which implements the methods described herein. In particular, the number of active digital processing components comprised in the radio network are adapted based on an estimate of a required processing capacity for an estimated combined time-averaged traffic volume relating to the plurality of cells of the radio network, and transmissions relating to the plurality of cells are scheduled so that processing requirements of the transmissions do not exceed a processing capacity of the active digital processing components. For example, the number of active digital processing components may be adapted to the minimum number of active digital processing components which can provide the required processing capacity for the estimated combined time-averaged traffic volume.

In this example, it is determined that the estimated combined time-averaged traffic volume requires half (two out of four in this example) the number of digital processing components to be active. Thus, half of the digital processing components are deactivated. The shared resource scheduler, in this example located in the shared RAN compute node (although it will be appreciated that the scheduler could be provided anywhere in the network), ensures that the instantaneous compute requirements do not exceed the current configuration. This enables an adaptation of available digital processing components on a slower time scale. To enable this, a proportion of transmissions in a time slot where transmissions in the time slot would exceed the processing capacity of the active digital processing components may be delayed. In this example traffic from users B1 and B2 are delayed from time slot 1 to time slot 2. Traffic of user A2 is delayed from timeslot 4 to time slot 5, etc.

As can be seen in this example, the multi-cell scheduling process does not allow peak processing loads to exceed the processing capacity of a current configuration (indicated by the dashed line in FIG. 6b) of the digital processing components. It is noted that the coordinated multi-cell scheduling does not reduce the inter-cell interference in this example, and hence it differs from methods such as ICIC and CoMP. In this embodiment the two cells A and B could operate on different frequency bands or belong to different RATs. Furthermore, the processing workload in the shared RAN compute node could be uplink, downlink, or both uplink and downlink (for the sake of illustration only downlink traffic is depicted in FIG. 6a and FIG. 6b).

It will be appreciated in any of the examples described herein that the estimated combined time averaged traffic volume may be estimated based on any appropriate preceding time period, or using an algorithm able to predict future traffic volumes.

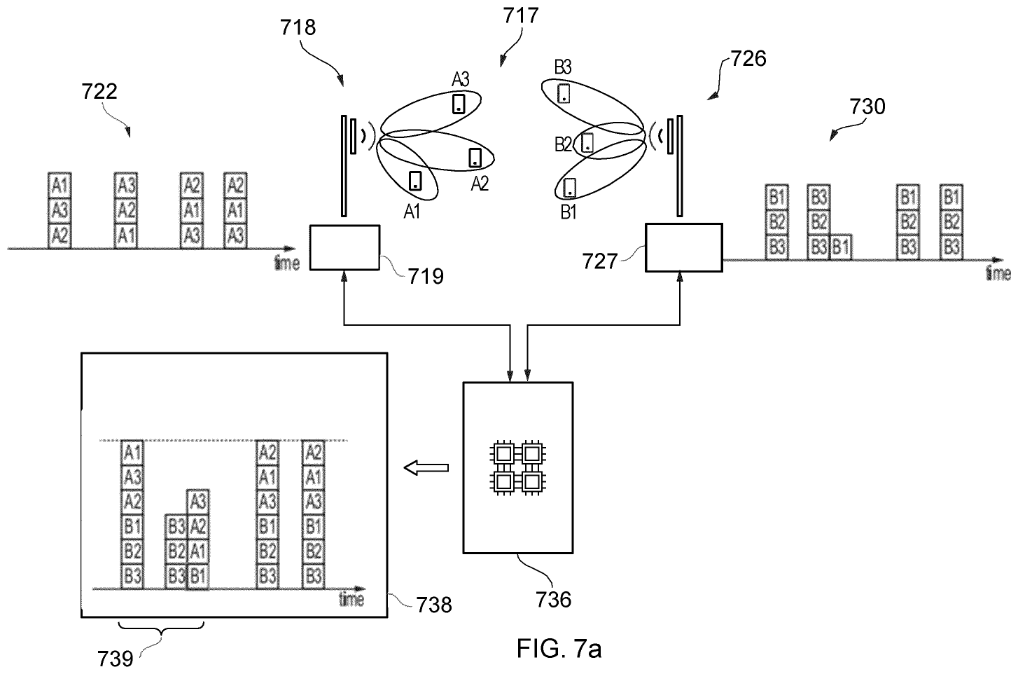

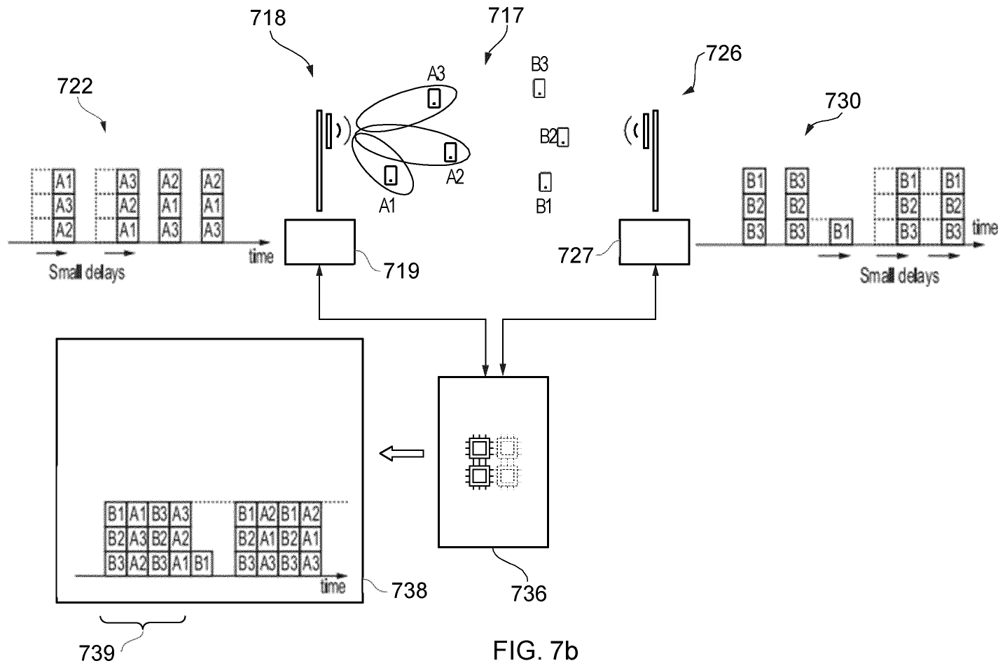

A further example is illustrated in FIG. 7, where FIG. 7a illustrates a configuration of a radio network, and FIG. 7b illustrates a configuration of a radio network which implements the methods described herein. In particular, FIG. 7b illustrates an example in which the methods are used in combination with a LESS scheduler that aims to maximize the amount of DTX per cell.

FIG. 7a illustrates an example of a radio network. In particular, FIG. 7a illustrates a radio network 717 comprising cell A 718 and cell B 726 served by radio unit A 719 and radio unit B 727 respectively. Cell A 718 and cell B 726 share the same compute resources 736 (in this example, compute resources of the same RAN compute node). Each cell serves three UEs (A1, A2, A3 in cell A 718 and B1, B2, B3 in cell B 726). The scheduled transmissions 722 corresponding to cell A and the scheduled transmissions 730 corresponding to cell B are illustrated here, where this traffic has been scheduled using a LESS scheduler. The combined transmissions 738 of cell A and cell B is also illustrated.

In this example, cell A 718 and cell B 726 schedule transmissions independently of each other using LESS so that the baseband workload will vary with the sum of the traffic (e.g the combined transmissions 738) (e.g. the sum of the individual workloads/traffic from cell A and cell B). This further implies that the base band hardware needs to be dimensioned accordingly, e.g. by assuming the worst case in the sense that maximum load can occur simultaneously in both cell A and cell B (illustrated by the dashed line of the baseband work load in FIG. 7a).

If the time required to activate additional compute resources is larger than the traffic transmission time interval (TTI) it is not possible to reduce energy consumption in the shared RAN compute node by deactivating some of the digital processing components, as otherwise the digital processing components will not be available for traffic when required. For example, if the activation time of the compute resources 739 takes four time slots, it is not possible for the compute resources to be turned on and off between traffic peaks in the example shown in FIG. 7a.

In FIG. 7b the radio network 717 is again illustrated but in this example it is operating using methods described herein. In particular, FIG. 7b illustrates a radio network 717 comprising cell A 718 and cell B 726 served by radio unit A 719 and radio unit B 727 respectively. Cell A 718 and cell B 726 share the same digital processing components (compute resource 736, in this example, compute resources of the same RAN compute node). Each cell serves three UEs (A1, A2, A3 in cell A 718 and B1, B2, B3 in cell B 726). The scheduled transmissions 722 corresponding to cell A and the scheduled transmissions 730 corresponding to cell B are illustrated here, where this traffic has been scheduled using LESS schedulers, thereby maximizing the number of discontinuous transmissions of the cells.

However, in this example, the number of active digital processing components comprised in the radio network is adapted based on an estimate of a required processing capacity for an estimated combined time-averaged traffic volume relating to the plurality of cells of the radio network; and transmissions relating to the plurality of cells are scheduled so that processing requirements of the transmissions do not exceed a processing capacity of the active digital processing components. Thus, the combined scheduled transmissions 738 for cell A and cell B does not exceed the processing capacity of the active digital processing components which is illustrated by the dotted line.

In this example, the estimate of a required processing capacity is based on an estimated combined time-averaged traffic volume, and the scheduling is based on scheduling one cell per time slot. The scheduling of transmissions may comprise scheduling at least two cells of the plurality of cells in different time slots.

Here, the digital processing components (e.g. base band hardware) have been configured under the assumption of a maximum load according to a maximum load per cell. The scheduler then delays the traffic of cell A and cell B in a coordinated manner where needed in order that the transmissions do not exceed the processing capacity of the active digital processing components. In this way the scheduler will ensure that the maximal possible baseband workload does not exceed the current configuration.

In the example of FIG. 7b, this is at least partly achieved by scheduling traffic from the cells in different time slots so that only one cell is active at a time. In particular, the traffic of the cells are scheduled so that only one cell is active in each time slot, in this example by delaying some transmissions as is illustrated in FIG. 7b. By scheduling one cell at a time the peak workload in the shared digital processing components is reduced by 50% in this example. It is noted that the number of DTX in each individual cell does not change due to the scheduling of the transmissions in this manner, which means that the energy saving in the radio unit power amplifiers is not reduced.

A further benefit of this example is that intercell interference is decreased. As is illustrated in FIG. 7b, when cell A is transmitting, cell B is quiet. When cell A is receiving uplink transmissions from the UEs A1, A2, and A3 the users in cell B (B1, B2, and B3) are not scheduled. Since there is less intercell interference, the spatial processing (i.e. beamforming) can be simplified which again reduces energy consumption due to processing.

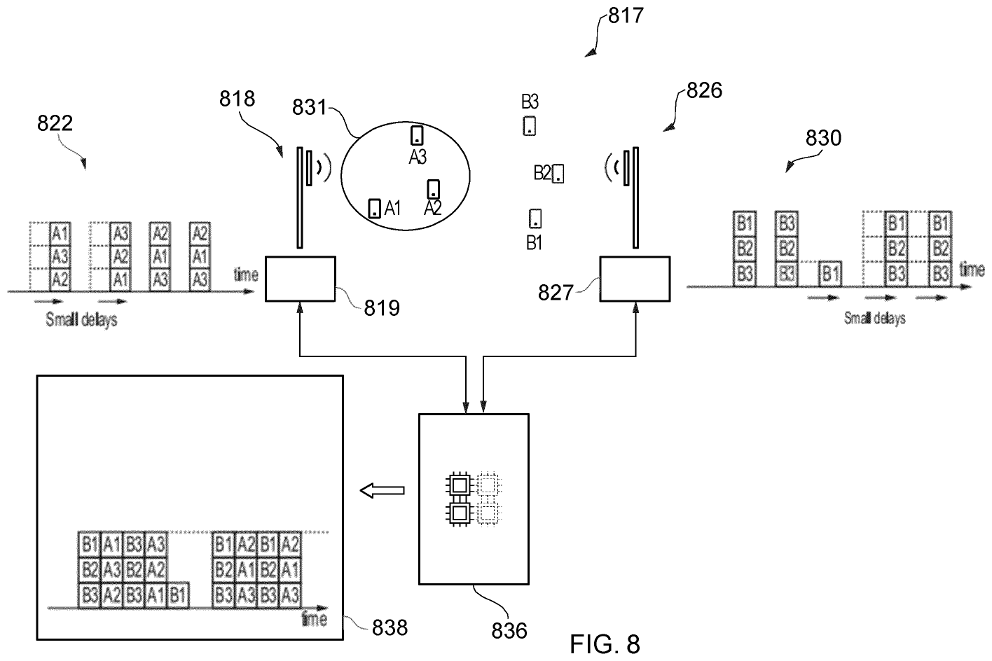

FIG. 8 illustrates a further example in which the methods described herein, and shows the same configuration as in FIG. 7b, but additionally comprising scheduling in combination with inter-cell interference coordination. In particular, FIG. 8 illustrates an example in which a relaxed transmission format is used in a currently active cell (enabled by inter-cell interference coordination).

FIG. 8 illustrates a radio network 817 comprising cell A 818 and cell B 826 served by radio unit A 819 and radio unit B 827 respectively. Cell A 818 and cell B 826 share the same compute resource 836 (in this example, the same RAN compute node). Each cell serves three UEs (A1, A2, A3 in cell A 718 and B1, B2, B3 in cell B 726). The scheduled transmissions 822 corresponding to cell A and the scheduled transmissions 830 corresponding to cell B, which have been scheduled using LESS, are illustrated here. As is described in relation to FIG. 7b, the methods described herein are applied.

As is noted in relation to the example of FIG. 7b, the intercell interference is decreased by the methods described above. Since there is less intercell interference, the spatial processing 831 (i.e. beamforming) of cell A can be simplified, which is shown in FIG. 8. Users in the same cell that are scheduled at the same time can be coordinated in the frequency domain and there is less need to try to limit the interference by applying advanced special processing algorithms (e.g. zero forcing transmission and/or MMSE interference rejection combining). Alternatively, a larger bandwidth can be allocated to the scheduled users (UEs) in the currently active cell. Whenever the currently active cell does not fill up the entire bandwidth it is possible to use less spectral efficient transmissions (such as lower order modulation). Normally this would result in increased intercell interference and it should be avoided even during low traffic. In this example, however, when cell A is active there are no active transmissions in the neighboring cell B, so this does not degrade the performance in cell B. Additional advantages are that the interference is not only reduced on average, but also in variance. This makes interference prediction simpler, resulting in more accurate link adaptation and reduced re-transmissions. Thus, at least one cell may use a reduced performance transmission format for transmission. The reduced performance transmission format may comprise at least one of: lower order modulation; larger bandwidth; wider beamforming; no interference suppressing beamforming; no data compression.

Simpler spatial processing and a less spectral efficient transmission format can enable additional power savings. For example, in this case there is no need to calculate advanced beamforming parameters which requires a lot of computational effort. Furthermore, the power amplifiers in the radio units can operate with relaxed linearity requirements which also enables significant additional energy savings.

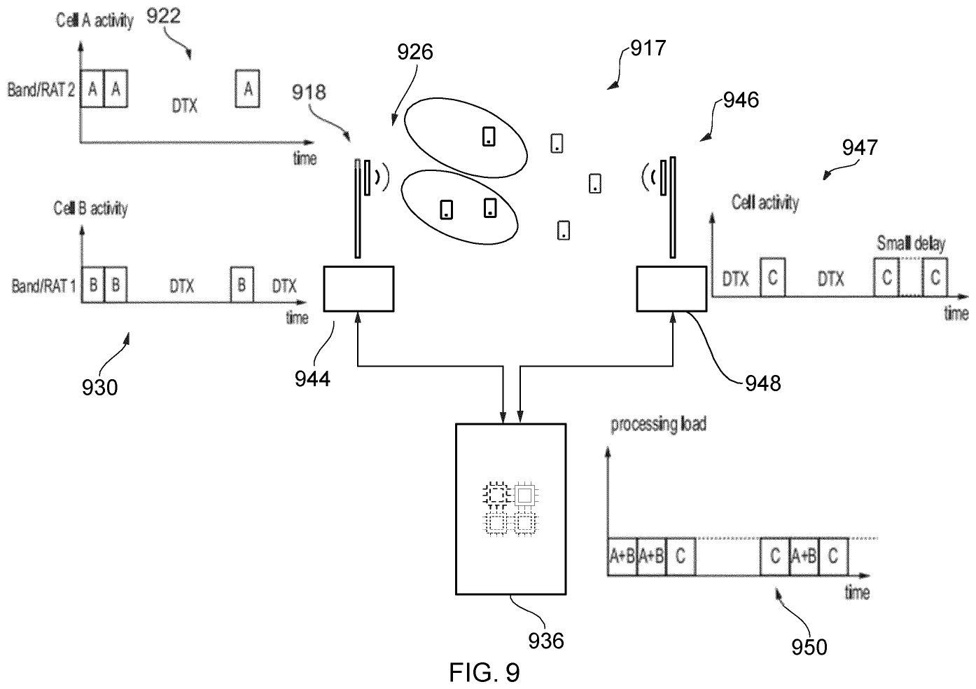

In a further example, the methods described herein are implemented in a multi-band scenario where the same radio unit serves multiple cells. FIG. 9 illustrates a radio network 917 in which a multi-band radio unit 944 serves cell A 918 and cell B 926, and processes the traffic 922 corresponding to cell A and the traffic 930 corresponding to cell B. These cells are co-scheduled since they share the same radio unit, where cell A and cell B operate in different bands (e.g. cell A in band/RAT 2 and cell B in band/RAT 1). The multi-band radio unit 944 is only deactivated when both cell A 918 and cell B 926 are inactive at the same time. The third cell in this example, cell C 946 which is served by radio unit C 948 which processes the traffic 947 corresponding to cell C, is not scheduled when cell A 918 or cell B 926 are active. Scheduling of the combined transmissions 950 of cell A, cell B and cell C is also illustrated in this figure. The multi-band radio unit 944 and the radio unit C 948 are in communication with shared compute resources 936.

The radio network implements similar methods to those described above, in particular adapting the number of active digital processing components comprised in a radio network based on an estimate of a required processing capacity for an estimated combined time-averaged traffic volume relating to a plurality of cells of the radio network; and scheduling transmissions relating to the plurality of cells so that processing requirements of the transmissions do not exceed a processing capacity of the active digital processing components. In addition, in this example, for the scheduling cells that share a multi-band radio unit are scheduled in the same time slots. Furthermore, cells that do not share a multi-band radio unit are scheduled in different time slots to time slots of cells that share the multi-band radio unit.

Thus, cells sharing the same multi-band radio unit may be co-scheduled to enable sleep activation in the radio units. Cells using different radio units should not be co-scheduled to enable energy savings in the shared base band processing unit. In this example, cells A and B are scheduled in the same time slots, whereas cell C is scheduled in time slots in which either cell A or B is scheduled. As is shown in this Figure, this is achieved by delaying traffic from cell C slightly in order that the traffic is not in the same time slot as cell A or B.

As is illustrated in this Figure, the method implemented in this example enables only a quarter of the digital processing components to be active. Therefore, processing requirements are reduced, and energy consumption is reduced.

In another example, the digital processing components are interfaces of a transport connection (e.g. a fronthaul connection—such as a fibre based connection in RAN infrastructure between a baseband unit and a remote radio head). Typically, fronthaul interfaces cannot be reconfigured to a lower transmission rate with a lower energy consumption. The use of a SOTA low-energy scheduling solution would increase the traffic peaks even during periods of low traffic. Using the methods described herein, the peak bandwidth of the fronthaul connection may be reduced during most operational hours in most fronthaul links in the network. In particular, the method comprises adapting the number of active digital processing components (in this case, interfaces of a transport connection between the plurality of cells and a centralized processing unit) comprised in a radio network based on an estimate of a required processing capacity for an estimated combined time-averaged traffic volume relating to a plurality of cells of the radio network; and scheduling transmissions relating to the plurality of cells so that processing requirements of the transmissions do not exceed a processing capacity of the active digital processing components. A proportion of cells scheduled in the same time slots may correspond to the processing capacity of the active interfaces. Fewer cells may be scheduled in the same time slot when the processing capacity of the active interfaces is lower.

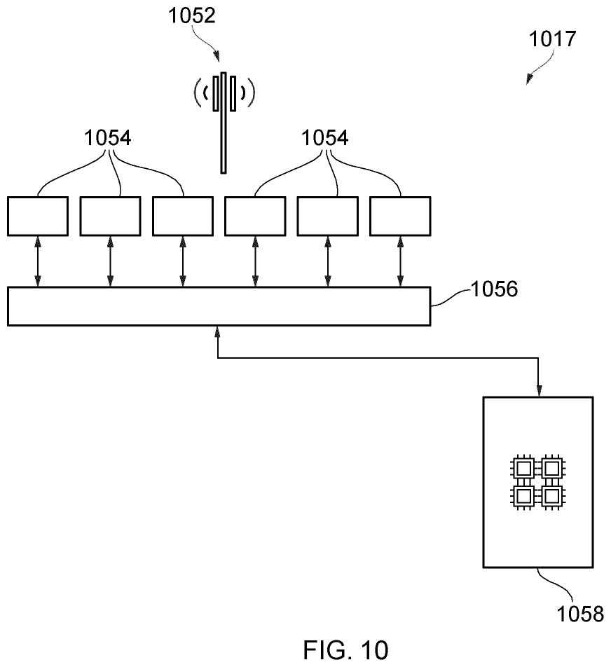

FIG. 10 illustrates an example of a radio network 1017 where multiple cells 1052 each served by a radio unit 1054 share the same transport connection 1056 towards a centralized processing unit 1058 (e.g. active digital processing components such as the compute resources of compute nodes described above, in this example a shared RAN compute node). This example relates to a transport connection which is a shared fronthaul interface (e.g. a fronthaul link, eCPRI), but it will be apparent that the example is equally applicable to shared backhaul transmission interfaces. In particular, FIG. 10 illustrates an example deployment with six cells (for example, 2 bands, 3 sectors) sharing the same fronthaul connection towards a shared RAN compute unit which is required to provide a sufficient data transfer rate to support all cells. For example, to provide each cell with e.g. 10 Gbps a total of 60 Gbps is required. A common configuration is to use one, two, or four 25 Gbps interfaces for the fronthaul link (in this example two would be insufficient) to provide a rate of 10-100 Gbps.

In order to reduce energy consumption, the rate of a shared fronthaul connection. can be reduced according to methods described herein. Table 1 below outlines various fronthaul connection configurations that could be applied to the network of FIG. 10. In this example the six cells in FIG. 10 share a fronthaul connection. Based on an estimate of a required processing capacity for an estimated combined time-averaged traffic volume relating to the plurality of cells, for example to determine the estimated traffic, the number of active fronthaul connections (e.g. fronthaul links) can be adapted. For example, if peak traffic occurs 10% of the time the full capacity configuration is not required most of the time. It has been determined by the inventors of the present application that, when traffic is lower, the fronthaul rate could be scaled down to a reduced value, thereby enabling energy savings. The number of cells scheduled in the same time slot may be based on the estimate of a required processing capacity. The number of cells scheduled in the same time slot may be proportionate with respect to the proportion of processing capacity required. For example, in the case where there are multiple (e.g. 25 GHZ) fronthaul links, a sub-set of the fronthaul links could be activated and the others powered off. In order to enable a proportion of the fronthaul links to be powered off, the scheduler may prevent scheduling of all cells at peak traffic at the same time. In this example it is assumed that in a reduced state at most 3 cells can be scheduled simultaneously and in a minimal state at most 1 cell can be scheduled with peak traffic (or alternative 3 cells can be served with reduced bandwidth).

TABLE 1
Example of three fronthaul configurations for a radio base
station with 6 cells.

| Fronthaul | Maximum number of cells | |
|---|---|---|
| capacity mode | active in same time slot | Usage example |
| Full (e.g. 100 %) | 6 | Peak traffic |
| | | (e.g. 10% of the |
| | | time) |
| Reduced (e.g. 50%) | 3 | Medium traffic |
| | Example: | (e.g. 60% of the |
| | Each cell scheduled | time) |
| | every 2^{nd} time slot | |
| Minimal (e.g. 10%) | 1 (with reduced BW) | Low traffic |
| | Example: | (e.g. 30% of the |
| | 1 band (3 cells) turned off | time) |
| | 3 remaining cells each scheduled | |
| | in different time slots | |

Furthermore, fronthaul data is often compressed to increase the throughput. This data compression requires significant processing at both ends for packing and unpacking the data. Where there is a reduction in the traffic of the cells due to the method described above, the data compression may be deactivated, and the hardware associated with the data compression powered off. Thus, a reduced performance transmission format may be used, and therefore energy savings may be made.

Therefore, in addition to enable energy savings in a compute node (for example, shared baseband processing unit), the examples described herein can also enable savings in the transport network equipment. High traffic peaks require a high fronthaul data rate configuration even if the high peak traffic occurs sporadically. By adapting the number of active digital processing components comprised in a radio network based on an estimate of a required processing capacity for an estimated combined time-averaged traffic volume relating to a plurality of cells of the radio network; and scheduling transmissions relating to the plurality of cells so that processing requirements of the transmissions do not exceed a processing capacity of the active digital processing components, the fronthaul data rate may be reduced.

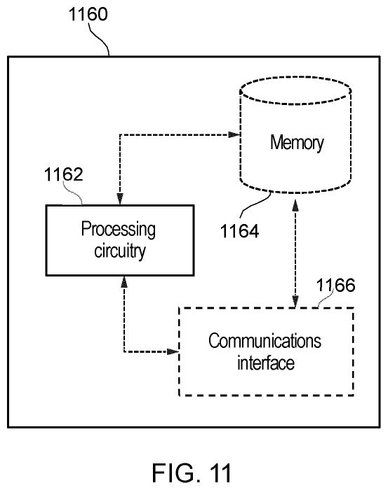

As illustrated in FIG. 11, in aspects of embodiments a system 1160 comprises processing circuitry (or logic). The system may be a radio network or may be components within a radio network. For example, the system may be comprised in a compute node (e.g. a baseband compute node). The processing circuitry 1162 controls at least a part of the operation of the system 1160 and can implement the methods described herein in respect of the system 1160. The processing circuitry 1162 can be configured or programmed to control the system 1160 in the manner described herein. The processing circuitry 1162 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the system 1160. In some embodiments, the processing circuitry 1162 can be configured to run software to perform the method described herein in respect of the system 1160. The software may be containerised according to some embodiments. Thus, in some embodiments, the processing circuitry 1162 may be configured to run a container to perform the method described herein in respect of the system 1160.

Briefly, the processing circuitry 1162 of the system 1160 is configured to adapt the number of active digital processing components comprised in a radio network based on an estimate of a required processing capacity for an estimated combined time-averaged traffic volume relating to a plurality of cells of the radio network. The processing circuitry 1162 is further configured to schedule transmissions relating to the plurality of cells so that processing requirements of the transmissions do not exceed a processing capacity of the active digital processing components.

As illustrated in FIG. 11, in some embodiments, the system 1160 may optionally comprise a memory 1164. The memory 1164 of the system 1160 can comprise a volatile memory or a non-volatile memory. In some embodiments, the memory 1164 of the system 1160 may comprise a non-transitory media. Examples of the memory 1164 of the system 1160 include, but are not limited to, a random access memory (RAM), a read only memory (ROM), a mass storage media such as a hard disk or a solid state drive (SSD), a removable storage media such as a compact disk (CD) or a digital video disk (DVD), and/or any other memory.

The processing circuitry 1162 of the system 1160 can be connected to the memory 1164 of the system 1160. In some embodiments, the memory 1164 of the system 1160 may be for storing program code or instructions which, when executed by the processing circuitry 1162 of the system 1160, cause the system 1160 to operate in the manner described herein in respect of the system 1160. For example, in some embodiments, the memory 1164 of the system 1160 may be configured to store program code or instructions that can be executed by the processing circuitry 1162 of the system 1160 to cause the system 1160 to operate in accordance with the method described herein in respect of the system 1160. Alternatively or in addition, the memory 1164 of the system 1160 can be configured to store any information, data, messages, requests, responses, indications, notifications, signals, or similar, that are described herein. The processing circuitry 1162 of the system 1160 may be configured to control the memory 1164 of the system 1160 to store information, data, messages, requests, responses, indications, notifications, signals, or similar, that are described herein.

In some embodiments, as illustrated in FIG. 11, the system 1160 may optionally comprise a communications interface 1166. The communications interface 1166 of the system 1160 can be connected to the processing circuitry 1162 of the system 1160 and/or the memory 1164 of system 1160. The communications interface 1166 of the system 1160 may be operable to allow the processing circuitry 1162 of the system 1160 to communicate with the memory 1164 of the system 1160 and/or vice versa. Similarly, the communications interface 1166 of the system 1160 may be operable to allow the processing circuitry 1162 of the system 1160 to communicate with other parts of a radio network. The communications interface 1166 of the system 1160 can be configured to transmit and/or receive information, data, messages, requests, responses, indications, notifications, signals, or similar, that are described herein. In some embodiments, the processing circuitry 1162 of the system 1160 may be configured to control the communications interface 1166 of the system 1160 to transmit and/or receive information, data, messages, requests, responses, indications, notifications, signals, or similar, that are described herein. The communications interface 1166 may be configured to communicate with other components of a radio network.

Although the system 1160 is illustrated in FIG. 11 as comprising a single memory 1164, it will be appreciated that the system 1160 may comprise at least one memory (i.e. a single memory or a plurality of memories) that operate in the manner described herein. Similarly, although the system 1160 is illustrated in FIG. 11 as comprising a single communications interface 1166, it will be appreciated that the system 1160 may comprise at least one communications interface (i.e. a single communications interface or a plurality of communications interface) that operate in the manner described herein. It will also be appreciated that FIG. 11 only shows the components required to illustrate an embodiment of the system 1160 and, in practical implementations, the system 1160 may comprise additional or alternative components to those shown.

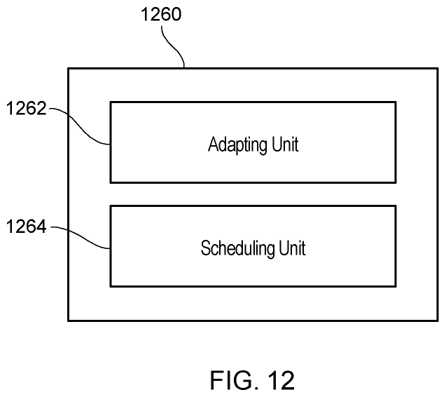

FIG. 12 illustrates a system 1260 according to an embodiment, the system 1260 comprising an adapting unit 1262 (adapter) configured to adapt the number of active digital processing components comprised in the network based on an estimate of a required processing capacity for an estimated combined time-averaged traffic volume relating to a plurality of cells of the radio network, and a scheduling unit 1264 (scheduler) configured to schedule transmissions relating to the plurality of cells so that processing requirements of the transmissions do not exceed a processing capacity of the active digital processing components.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method for a radio network, the method comprising:
adapting the number of active digital processing components comprised in a radio network based on an estimate of a required processing capacity for an estimated combined time-averaged traffic volume relating to a plurality of cells of the radio network; and
scheduling transmissions relating to the plurality of cells so that processing requirements of the transmissions do not exceed a processing capacity of the active digital processing components.

2. The method as claimed in claim 1, wherein the method further comprises, prior to the adapting of the number of active digital processing components;
obtaining the estimated combined time-averaged traffic volume relating to the plurality of cells; and
determining the estimate of the required processing capacity to support the estimated combined time-averaged traffic volume.

3. The method as claimed in claim 1, wherein the number of active digital processing components is adapted to the minimum number of active digital processing components which can provide the required processing capacity for the estimated combined time-averaged traffic volume.

4. The method as claimed in claim 1, wherein the scheduling further comprises scheduling transmissions so that transmissions in a time slot do not exceed the processing capacity of the active digital processing components.

5. The method as claimed in claim 1, wherein the scheduling comprises delaying a proportion of transmissions in a time slot where transmissions in the time slot would exceed the processing capacity of the active digital processing components.

6. The method as claimed in claim 1, wherein the scheduling further comprises maximizing the number of discontinuous transmissions of at least one cell of the plurality of cells.

7. The method as claimed in claim 1, wherein the number of cells scheduled in the same time slot is restricted to one cell per time slot.

8. The method as claimed in claim 1, wherein the scheduling of transmissions further comprises scheduling at least two cells of the plurality of cells in different time slots.

9. The method as claimed in claim 1, wherein cells that share a multi-band radio unit are scheduled in the same time slots.

10. The method as claimed in claim 1, wherein cells that do not share a multi-band radio unit are scheduled in different time slots to time slots of cells that share the multi-band radio unit.

11. The method as claimed in claim 1, wherein the number of cells scheduled in the same time slot is based on the estimate of a required processing capacity.

12. The method as claimed in claim 7, wherein at least one cell uses a reduced performance transmission format for transmission.

13. The method as claimed in claim 12, wherein the reduced performance transmission format comprises at least one of: lower order modulation; larger bandwidth; wider beamforming; reduced complexity interference suppression beamforming; no interference suppressing beamforming; no, or less, data compression.

14. The method as claimed in claim 1, wherein the processing capacity is based on at least one of: uplink; downlink; both uplink and downlink.

15. The method as claimed in claim 1, wherein user equipment, UEs, in the same cell and scheduled in the same time slot are coordinated in the frequency domain.

16. The method as claimed in claim 1, wherein the digital processing components are shared hardware resources comprised in a compute node serving the plurality of cells.

17. The method as claimed in claim 16, wherein the shared hardware resources comprise at least one of: a central processing unit core, a digital signal processor core, an accelerator core, an application-specific integrated circuit, a field programmable gate array.

18. The method as claimed in claim 1, wherein the digital processing components are interfaces of a transport connection between the plurality of cells and a centralized processing unit.

19. The method as claimed in claim 18, wherein a proportion of cells scheduled in the same time slots corresponds to the processing capacity of the active interfaces.

20. (canceled)

21. A system for reducing energy consumption of a radio network, the system comprising:
an adapter configured to adapt the number of active digital processing components comprised in the network based on an estimate of a required processing capacity for an estimated combined time-averaged traffic volume relating to a plurality of cells of the radio network; and
a scheduler configured to schedule transmissions relating to the plurality of cells so that processing requirements of the transmissions do not exceed a processing capacity of the active digital processing components.

22-28. (canceled)
